(19) United States
(12) Patent Application Publication
(10) Pub. No.: US 2023/0377354 A1
(43) Pub. Date: Nov. 23, 2023

(54) CONTINUOUS DETECTION AND SPECIES CLASSIFICATION OF BIOLOGICAL PARTICLES IN A SAMPLE

(71) Applicant: KUARTO GROUP APS, København N (DK)

(72) Inventors: Darius Adam Rohani, Copenhagen Ø (DK); Daniel Lundt Mersebak, Copenhagen S (DK); Nicolai Scherling Mersebak, Dragør (DK); Kristoffer Kampmann, Gentofte (DK)

(21) Appl. No.: 18/247,909

(22) PCT Filed: Oct. 8, 2021
(86) PCT No.: PCT/EP2021/077968

§ 371 Date: Apr. 5, 2023

(30) Foreign Application Priority Data
Oct. 8, 2020 (EP) 20200758.9

(51) Int. Cl. G06V 20/69; G06V 10/82

(52) U.S. Cl. CPC G06V 20/698; G06V 20/693; G06V 10/82

(57) ABSTRACT

A method for continuous detection and species classification of biological particles in a sample includes continuously scanning along at least a part of the sample. The scanning includes: a. obtaining an image of a part of the sample, by a measurement unit; b. displacing the sample relative to the measurement unit; c. obtaining an additional image of an additional part of the sample, by the measurement unit, the additional image overlapping at least in part with a last image; d. forming a scanning sequence with multiple recently obtained images; e. analyzing the sequence for the presence of the biological particles, by a trained machine learning model, such as a convolutional neural network model, thereby obtaining a scanning indicator; f. providing the scanning indicator and a scanning sequence image, such as the last image; and g. repeating steps b-f; thereby continuously detecting and species classifying biological particles in the sample.

### CROSS-REFERENCE TO RELATED APPLICATIONS

This application is the U.S. National Stage of PCT/EP2021/077968 filed on Oct. 8, 2021, which claims priority to European Patent Application 20200758.9 filed on Oct. 8, 2020, the entire content of both are incorporated herein by reference in their entirety.

### FIELD OF THE INVENTION

The present disclosure relates to methods, measurement units, and systems for continuous detection and species classification of biological particles in a sample. A method comprises forming a scanning sequence comprising multiple recently obtained images of a sample and analyzing the scanning sequence for the presence of biological particles, by a trained machine learning model, to obtain a scanning indicator.

### BACKGROUND OF THE INVENTION

Molds are a large and taxonomically diverse number of fungal species in which the growth of hyphae results in discoloration and a fuzzy appearance, especially on food.

There are thousands of known species of molds, which have diverse lifestyles. They have in common that they all require moisture for growth, and some live in aquatic environments. Like all fungi, molds derive energy not through photosynthesis but from the organic matter on which they live, utilizing heterotrophy.

Some molds are beneficial and desirable, for example in food products, including cheeses such as blue cheese, Gorgonzola, Brie, and Camembert, dry-cured country hams, and bread. However, other types of molds can be toxic and pose very serious health threats to humans. The presence of specific mold species may for example lead to an amplification of a poor indoor quality resulting in significant respiratory problems, including allergic reactions, flu-like symptoms and worsening of asthma.

The fact that specific mold species are desirable while others may be toxic also holds true for other types of biological particles, such as virus and bacteria. Consequently, it is crucial to understand what specific biological particle species are present in a particular environment or a specific product before any conclusions about the effect of said biological particles can be drawn.

Furthermore, for an indoor environment, detection and species classification of mold spores may be carried out to find the location of the mold, such that molded parts can be treated or replaced. Another reason for the detection and species classification is to find out what treatment to use, as specific biological particle species may respond differently to specific cleaning agents. Further, it may be carried out for quality assurance, either of an indoor environment or of a food product, for example as in-line process control in production. As non-hazardous biological particles, such as specific mold spores species, are regularly present at certain levels in our environment, and biological particles are further desirable in certain food products, classification of biological particle species is required to find out if a specific environment or a particular product contains an undesirable biological particle species or not.

### SUMMARY OF THE INVENTION

The present disclosure relates to methods and apparatuses for detection and species classification of biological particle species. A preferred embodiment of the present disclosure relates to continuous detection and species classification by scanning of a sample. This may be used to provide a user with continuous feedback of the scanning, wherein the user may modify the scanning based on the provided feedback for improving the measurement results.

Specifically, in a first aspect, the present disclosure relates to a method for continuous detection and species classification of biological particles in a sample. The method comprising:
a. Obtaining an image of a part of said sample, by a measurement unit;
b. Displacing the sample relative to the measurement unit;
c. Obtaining an additional image of an additional part of said sample, by the measurement unit;
d. Forming a scanning sequence comprising multiple recently obtained images;
e. Analyzing said scanning sequence for the presence of said biological particle, by a trained machine learning model, such as a convolutional neural network model, thereby obtaining a scanning indicator; and
f. Repeating, a number of times, steps b-e;

thereby continuously detecting and species classifying biological particles in the sample.

In an embodiment of the present disclosure, the displacement of the sample relative to the measurement unit may be performed by a user, e.g. the user may control the position and/or angle of the measurement unit while the sample is stationary. The measurement unit may for example be a hand-held device, such as a smartphone, that is controlled by the user. In other embodiments of the present disclosure, the relative movement between the sample and the measurement unit may be carried out by a control unit, such as a motorized XY stage or a production belt.

In an embodiment of the present disclosure, the method comprises a step of providing the scanning indicator and an image of the scanning sequence, such as the last image, between step e and f, in this embodiment it is a preference that the step of repeating comprises the repetition of said step of providing. The method may for example comprise providing the scanning indicator to a user and/or a control unit, such as a motorized XY stage or a production belt, wherein said user and/or control unit may, in step b. displace the sample relative to the measurement unit, based on said scanning indicator.

The scanning indicator may comprise any information derivable from the obtained images of the scanning sequences. The scanning indicator may, for example, include information about the classification of biological particle species in the scanning sequence, for example the most abundant type and/or the quantity of biological particle species. In an embodiment of the present disclosure, the scanning indicator is continuously updated and provided to the user together with an image of the scanning sequence, such as the most recent image. Based on the provided feedback, the user may modify the scan of the sample such that the most reliable measurement data can be obtained. It is a further preference that the scanning indicator is continuously updated and consists of only recently acquired images, for example images obtained within a predetermined time, such as the last second. This ensures that the user is provided with sensitive information of the presently imaged location of the sample.

In an embodiment of the present disclosure, the method of the present disclosure is carried out substantially in real-time, i.e. a user that is carrying out the method is provided with updated information, relevant for the recently obtained image. This includes i. updating of the scanning sequence, for example by replacing the oldest image of the scanning sequence with a newly acquired image; ii. analysis of the scanning sequence for deriving a scanning indicator; iii. providing the scanning indicator together with a recently obtained image.

In a further aspect, the present disclosure relates to a measurement unit for continuous detection and species classification of biological particles in a sample. The apparatus may be configured for continuous scanning of the sample by at least:
Obtaining an image of a part of said sample, by a measurement unit;
Displacing the sample relative to the measurement unit;
Obtaining an additional image of an additional part of said sample, by the measurement unit, said additional image overlapping at least in part with a last obtained image;
Forming a scanning sequence comprising multiple recently obtained images;
Analyzing said scanning sequence for the presence of said biological particles, by a trained convolutional neural network model, thereby obtaining a scanning indicator; and
Repeating, multiple times steps b-e;
thereby continuously detecting and species classifying biological particles in the sample.

In a preferred embodiment of the present disclosure, the number of images of the scanning sequence may be continuously and automatically adjusted, preferably based on the scanning indicator. Said number of images may, for example, depend on a predicted probability of detecting biological particles in the present field of view.

In an embodiment of the present disclosure, the method comprises a step of providing the scanning indicator and an image of the scanning sequence, such as the last image, between step e and f, in this embodiment it is a preference that the step of repeating comprises the repetition of said step of providing.

The measurement unit may be a portable, hand-held device, and may during the scanning be controlled by a user. In certain, embodiments of the present disclosure, the scanning indicator and the image of the scanning sequence is provided to said user, which may, based on this information, control the measurement unit such that the most reliable measurement data can be acquired. The user may for example displace the measurement unit based on the scanning sequence and/or said image, relative to the sample, to one or more areas where reliable information for the detection and species classification of biological particles in the sample can be acquired. Additionally or alternatively, in other embodiments of the present disclosure, the measurement unit may be stationary. The measurement unit may for example be provided as part of a system comprising a displacement unit configured for moving the sample relative to the measurement unit. The displacement unit may for example be arranged for in-line process control, and/or comprise or consists of an x-y stage or production belt.

In another embodiment of the present disclosure, the measurement unit is configured to provide a visual or audible indication, e.g. an alarm, if biological particles, such as mold and/or hazardous biological particles, are detected. In this embodiment of the present disclosure, the measurement unit may be hand-held or stationary during scanning of the sample, e.g. the measurement unit may be mounted in a fixed position. When the measurement unit identifies biological particles, such as mold or hazardous biological particles, said unit may be arranged to provide a visual or audible indication.

In a third aspect, the present disclosure relates to a system for continuous detection and species classification of biological particles in a sample, the system comprising:
A measurement unit configured for:
   a. Scanning at least a part of the sample, such that a number of images along at least a part of said sample is obtained;
   b. Transferring the obtained images to a remote server;
   c. Repeating, a number of times, steps a-b;
The remote server configured for:
Receiving said obtained images;
Forming a scanning sequence comprising multiple recently received images;
Analyzing said scanning sequence for the presence of said biological particles, by a trained machine learning model, such as a convolutional neural network model, thereby obtaining a scanning indicator; and
Transferring the scanning indicator to the measurement unit.

In a preferred embodiment of the present disclosure, the remote server and/or measurement unit is configured to form a scanning sequence comprising an adjustable number of recently obtained images. Said number of images may for example depend on a predicted probability of detecting biological particles in the present field of view.

In an embodiment of the present disclosure, the measurement unit is configured to also carry out a step of providing the scanning indicator and an image of the scanning sequence, such as the last image, between step b and c, in this embodiment it is a preference that the step of repeating, c, comprises the repetition of said step of providing, i.e. said repetition may comprise scanning, transferring and providing.

While machine learning models are typically highly versatile and offer high accuracy and precision, they may be resource-demanding. The requirement of computational power may not always be met by a portable, hand-held, measurement unit. Therefore, the present disclosure relates to a computational infrastructure that allows for rapid, accurate and precise detection and species classification of biological particles in the sample, by using a measurement unit that comprises means for communication with a remote server. The remote server is preferably configured to continuously process obtained data, such as obtained images, and return a scanning indicator to the measurement unit. This enables the use of a cost-effective and straightforward measurement unit, while still producing reliable measurement results. A further advantage of the present disclosure is that the machine learning model may continuously be updated, and also selected based on the current sample. Multiple measurement units may be connected to the remote server, and thereby it may be ensured that the obtained images of all measurement units are processed by the most recently updated version of the machine learning model.

### BRIEF DESCRIPTION OF THE DRAWINGS

FIG. 1 shows a schematic illustration of a system for continuous detection and species classification of biological particles in a sample, according to a specific embodiment of the present disclosure;

FIG. 2 shows a process for continuous detection and species classification of biological particles in a sample, according to a specific embodiment of the present disclosure;

FIG. 3 shows a process for continuous detection and species classification of biological particles in a sample, according to a specific embodiment of the present disclosure; and

FIG. 4 shows illustrations of feedback in the form of an image of a sample and a scanning indicator, obtained by analysing obtained images, according to a specific embodiment of the present disclosure.

### DETAILED DESCRIPTION OF THE INVENTION

### Definitions

Scanning

As used herein, “scanning” refers to the acquisition of multiple images of a sample. Preferably at least a part of said images is of different areas of the sample. Further, it is a preference that the multiple images at least partly overlap.

Image

As used herein, “image” refers to a digital entity composed of picture elements, also known as pixels, each with finite, discrete quantities of numeric representation for its intensities (e.g. color intensities) and/or gray level that is an output from its two-dimensional functions fed as input by its spatial coordinates denoted with x, y on the x-axis and y-axis, respectively. Depending on whether the image resolution is fixed, it may be of vector or raster type.

Biological Particle

As used herein, “biological particle” refers to any organism, a fragment thereof, or organic structures that interact with living organisms. Exemplary biological particles include mold, mold spores, bacteria, virus, fragments thereof, or particles shed therefrom.

Sample

As used herein, “sample” refers to any material to be tested, such as, for example, an environmental sample, or a food sample, including foodstuff. An environmental sample may be obtained from any environment, such as, for example, an indoor environment, an outdoor environment, an environment at, or near, a ventilation system. Of specific interest are environment samples obtained from surfaces or air in an indoor environment. For samples obtained from surfaces, the surfaces are typically selected based on the expectancy of them to comprise biological particles, such as mold spores. Such surfaces may for example be floor moldings, window sills, or other surfaces where biological particles may be expected to be present. Typically substantially flat and horizontal surfaces may be of interest. Furthermore, surfaces at or near ventilation outlets may be of interest as biological particles that stem from the ventilation system, or other areas in connection with the ventilation system may settle at these surfaces. Samples obtained from surfaces may be obtained by for example tape sampling, wherein particles on said surface adhere to a tape that subsequently is typically adhered to a glass slide, or any other mounting means before imaging. For samples obtained by air, particles may be collected from any air environment, wherein said particles typically adhere to a mounting means, such as a glass slide. Typical air environments may be near or at any part of a ventilation system, and/or any environment wherein humans or animals reside. For example, air samples may be obtained from inside a home or an office, typically to measure the quality of the indoor climate. Air sampling may comprise the use of a filter having a smaller pore size than the typical size of a biological particle, such as a mold spore. A food sample may be obtained from any type of food that is to be tested. For example the food may be a dairy product, such as cheese. In another embodiment biological samples can be obtained from any organism. In one embodiment, a sample can be obtained from a mammal, such as a human, companion animal, or livestock. A sample can also be obtained from other animals, such as a bird. In one embodiment, a sample from an animal comprises a nasopharyngeal aspirate, blood, saliva, feces, urine, or any other bodily fluid. Irrespective of whether the sample has been obtained from a surface, by air, or as part of a product, the sample may be processed before analysis. For example, the sample may be provided on an agar plate, containing suitable agar media.

Classification

As used herein, “classification” refers to the process of categorizing and/or labeling groups of pixels or vectors within an image based on specific rules. The categorization law can be devised using one or more spectral or textural characteristics, and may further belong to supervised classification, unsupervised classification and/or a mixture thereof. Typically, the classes are predefined, e.g. the classifier, such as a machine learning model, may have been pre-trained with specific classes. Of specific interest is the classification of organisms into any level of the taxonomy. It may be a preference that the classification comprises or consists of species classification or the basic ranks, i.e. species and genus. However, any taxonomy level(s) may be relevant. For example species, genus, family, order, class, phylum, kingdom and/or domain.

Measurement Unit

As used herein, “measurement unit” refers to a device comprising an optical instrument used to record images. Typically, the optical instrument as a minimum comprises an aperture in a sealed box (i.e. a body). The aperture being configured such that it allows light in to capture an image on a light-sensitive surface (typically a digital image sensor). The measurement unit may, in specific embodiments of the present disclosure, further comprise an output device for presentation of information in visual or tactile format, preferably a display. The display may for example provide, to a user of the measurement unit, an obtained image together with a scanning indicator. The measurement unit may be handheld and may comprise means for communication with a remote server. The measurement unit may comprise a processing unit, a memory, and a battery. In a particular embodiment of the present disclosure, the measurement unit is a smartphone. The measurement unit may be configured to, during use, be held in the hand of a user, or the measurement unit may be, or be configured to, be fixed in position. While the measurement unit is fixed in position the area imaged may be non-stationary. In specific embodiments of the present disclosure, the relative movement between the sample and the measurement unit may be carried out by a control unit, such as a motorized XY stage or a production belt.

Mold

As used herein, “mold” refers to a fungus that grows in the form of multicellular filaments (i.e. hyphae). Molds are a large and taxonomically diverse number of fungal species in which the growth of hyphae results in discoloration and a fuzzy appearance, especially on food. There are thousands of known species of molds, which have diverse life-styles including saprotrophs, mesophiles, psychrophiles and thermophiles and a very few opportunistic pathogens of humans. They all require moisture for growth and some live in aquatic environments. Like all fungi, molds derive energy not through photosynthesis but from the organic matter on which they live, utilizing heterotrophy.

Molds reproduce by producing large numbers of small spores, which may contain a single nucleus or be multinucleate. Mold spores can be asexual (the products of mitosis) or sexual (the products of meiosis); many species can produce both types. Some molds produce small, hydrophobic spores that are adapted for wind dispersal and may remain airborne for long periods; in some the cell walls are darkly pigmented, providing resistance to damage by ultraviolet radiation. Other mold spores have slimy sheaths and are more suited to water dispersal. Mold spores are often spherical or ovoid single cells, but can be multicellular and variously shaped. Spores may cling to clothing or fur; some are able to survive extremes of temperature and pressure. The mode of formation and shape of these spores is traditionally used to classify molds. Many of these spores are colored, making the fungus much more obvious to the human eye at this stage in its life-cycle

Typically, molds secrete hydrolytic enzymes, mainly from the hyphal tips.

Mold growth in buildings generally occurs as fungi colonize porous building materials, such as wood. Many building products commonly incorporate paper, wood products, or solid wood members, such as paper-covered drywall, wood cabinets, and insulation. Interior mold colonization can lead to a variety of health problems as microscopic airborne reproductive spores, analogous to tree pollen, are inhaled by building occupants. High quantities of indoor airborne spores as compared to exterior conditions are strongly suggestive of indoor mold growth. The determination of airborne spore counts may be accomplished by way of an air sample. For example by use of an agar plate that collects mold spores in the environment, e.g. a room. Alternatively or additionally, mold samples may be collected by the use of a specialized pump with a known flow rate that is operated for a known period of time. To account for background levels, air samples should be drawn from the affected area, a control area, and the exterior. Such a configuration may allow for a more precise quantification of the mold spores.

Scanning Sequence

As used herein, “Scanning sequence” refers to a set of images of the sample and/or analysis results of said set of images. Typically the scanning sequence is obtained by the measurement unit and may comprise a predefined number of images. The number of images of the scanning sequence may be predetermined or modified, preferably continuously modified. In an embodiment of the present disclosure, the number of images of the scanning sequence is modified based on information of the scanning indicator, such as a prediction of the presence of mold.

Alternatively, the scanning sequence may comprise or consist of a predefined number of the most recently obtained images. Consequently, the scanning sequence may be continuously updated. The scanning sequence may be continuously formed, such as following each time a further image is obtained, by replacing the oldest image of the scanning sequence with the most recently obtained image. The images of the scanning sequence may be arranged in a specific order, for example in chronological order of when they were obtained. In a specific embodiment of the present disclosure, the scanning sequence is formed by analysis results from analysis of the obtained images, such as by a trained machine learning model. The scanning sequence may thereby comprise or consist of results of detection and species classification of biological particles by a machine learning model, additionally or alternatively the scanning sequence may comprise analysis by a machine learning model of the scanning conditions.

Machine Learning Model

As used herein, “a machine learning model” refers to a mathematical model that has been built based on sample data, (i.e. training data, in order to make predictions or decisions without being explicitly programmed to do so. The machine learning model may have been trained using supervised learning, unsupervised learning, semi-supervised learning, reinforcement learning, self-learning, feature learning, sparse dictionary learning, anomaly learning, robot learning, association rules. The model of the machine learning model may be an artificial neural network, a decision tree, a support vector machine, a regression analysis, a Bayesian network, a genetic algorithm, a training model, and/or federated learning.

Mold Spores

As used herein, “mold spores” refers to microscopic, multi-cellular organisms that reproduce asexually. Molds are fungi and they can grow in any environment with a constant source of moisture. During the growth process, mold spores begin to undergo chemical reactions that allow them to devour nutrients and multiply. Specific mold species are used in the manufacturing of dairy products, and as such are desired for this application. However, specific mold species may be undesirable, both for food but also for example in the environment, such as the indoor climate as discussed elsewhere herein. In a particular embodiment of the present disclosure the mold species belong to any of the following; Acremonium, Aureobasidium, Alternaria, Aspergillus, Botrytis, Chaetomium, Cladosporium, Epicoccum, Eurotium, Fusarium, Geotrichum, Monilia, Manoscus, Mortierella, Mucor, Neurospora, Oidium, Oospora, Penicillium, Rhizopus, Stachybotrys, Thamnidium, Trichoderma, Trichothecium, Trichophyton, and/or Wallemia.

Scanning Indicator

As used herein, “scanning indicator” refers to any type of information that may be obtained from processing of the scanning sequence and may indicate any property, including scanning conditions, such as state, level, location, magnitude, frequency, and/or amount, of any feature, such as biological particles, for example mold spores, or any other object in the sample, lighting, focus, background, contrast, scanning speed, in any or multiple images of said scanning sequence. The scanning indicator may be provided in any type of format, for example visual, auditory and/or tactile. The scanning indicator may for example be provided as text, color levels, brightness levels, symbols, color overlays, audio signals, predefined audio clips, haptic technology, such as vibrations. The scanning indicator may be provided together with an image of the scanning sequence, such as the most recently obtained image. The scanning indicator may comprise indicators of information related to the scanning condition, such as a lightning level, a scanning speed, a focus level, a background particle level, and/or a background contrast level. The scanning indicator may comprise a classification of the sample, for example, a classification of the present biological particles, for example mold spores. The classification may, for example, be the most abundant biological particle species, for example mold spores species, and/or the most significant species, for example the most toxic species.

Remote Server

As used herein, “remote server” refers to a computational unit having a processing unit, a memory, a power source and means of communication. It is a preference that the remote server has significant computational power, preferably more than the measurement unit. The remote server may be provided by cloud computing, for example the remote server may be a cloud server.

### DETAILED DESCRIPTION OF THE INVENTION

The present disclosure relates to methods, measurement units, and systems for continuous detection and species classification of biological particles in a sample.

In a first aspect, the present disclosure relates to a method for detection and/or classification of features and/or items in a sample. It is a preference that the method comprises continuous detection and classification. Continuous detection may be enabled by continuously processing obtained images in a suitable manner and after that continuously providing the results of said processing, such as to a user that carries out the method. In a specific embodiment of the present disclosure the classification comprises species classification. However, the classification may comprise any levels of the taxonomy, for example species, genus, family, order, class, phylum, kingdom, and/or domain. The classification may in a specific embodiment comprise or consist of the strain. It is a preference that the method includes continuous scanning of a part of a sample. Preferably said part comprises or consists of a surface, but said part might, in a specific embodiment of the present disclosure, be a volumetric part of the sample. It is a further preference that the method comprises scanning along at least a part of the sample. The scanning may thereby be a two-dimensional and/or three-dimensional scanning of the surface. A three-dimensional scan is typically obtained by acquisition of multiple two-dimensional images in planes that are substantially orthogonal to the scanning direction.

In a further embodiment of the present disclosure, the scanning comprises obtaining a first image of a part of said sample. It is a preference that a measurement unit obtains the one or more images.

The method may further comprise, following the acquisition of a first image of a part of the sample, displacing of the sample and/or the measurement unit. Said displacement is preferably carried out such that the measurement unit is directed at another surface of the sample, wherein said other surface might partly overlap with the surface of the first image. The displacement may be carried out by displacing the measurement unit and/or the sample. Alternatively or additionally, the measurement unit and/or the sample may be rotated. It is a further preference that an image (i.e. an additional image) is obtained from said another surface. The another surface is consequently an additional part of the sample with respect to the part of the sample in the first image. As mentioned, it is a preference that the first and the additional image at least partly overlap, such as partly overlap.

In an embodiment of the present disclosure, the process for obtaining the additional image may be repeated such that multiple images of the sample are obtained. It is a preference that each consecutively obtained image is at least partly overlapping, such as partly overlapping. Thereby, at least two images have been obtained. It is a further preference that the multiple images, such are used to form a scanning sequence comprising multiple recently obtained images. The scanning sequence may comprise a predefined number of recently obtained images, such as 2, or 3, or 4, or 5, or 6, or 7, or 8, or 9, or about 10, or about 15, or about 20, or about 30, or about 40, or about 50, or about 60, or about 70, or about 80, or about 90, or about 100, or more than 100 images.

It is a preference that the formed scanning sequence is analyzed, such as by a trained machine learning model. The machine learning algorithm may for example be a convolutional neural network model, thereby obtaining a scanning indicator. The analysis of the trained machine learning model preferably at least comprises an analysis of the scanning sequence for the presence of biological particles, for example mold spores. The trained machine learning model may however be configured to carry out alternative or additional analyses of the scanning sequence. For example the trained machine learning model may be configured to carry out analysis of the scanning sequence for the presence of biological particles, for example mold spores, for the species of said biological particles, and/or any other taxonomy level, of any biological particles present, the image acquisition conditions, such as the lighting, the contrast, the focus level, the scanning speed, and/or the steadiness of the measurement unit with respect to the sample (i.e. motion blur level), the meta data of the images of the scanning sequence. The meta data may for example comprise information related to the location of where the image was obtained, under what conditions the image was obtained, e.g. temperature, humidity, lighting. The meta data may comprise any additional information provided by the measurement unit, for example sensors of the measurement unit, such as for the temperature, the humidity and the lighting, GPS, and/or a time indicator.

In a preferred embodiment of the present disclosure, the scanning indicator is provided together with an image of the scanning sequence. The scanning indicator may be, as discussed elsewhere herein be provided in any format, for example visual, audible and/or tactile. In the case of an at least partly visual scanning indicator, said part may be provided on the same display unit as the image of the scanning sequence. For example said image may be provided together with an overlay comprising the scanning indicator. It should however be noted that the scanning indicator could, at least partly, be provided on a separate display unit. Furthermore, in cases where the scanning indicator comprises non-visual information, such as audible or tactile, these may be provided separate from said image of the scanning sequence. It should be noted that “together with an image of the scanning sequence” may refer to that the scanning indicator and the image of the scanning sequence is provided simultaneously. The scanning indicator and the image of the scanning sequence is thereby not necessarily used to form a composite image comprising the scanning indicator and the image of the scanning sequence but may be provided on separate display units or separate parts of the same display unit. Additionally, as mentioned above, the scanning indicator and the image of the scanning sequence may at least in part be in different formats, for example visual, audible and/or tactile, thereby they may be provided by different means to a user that is carrying out the presently disclosed method.

In a particular embodiment of the present disclosure, the method comprises a step of providing the scanning indicator and an image of the scanning sequence. The image may be any image of the scanning sequence, such as the most recently obtained image, an image that is selected based on the results of the analysis of said image, and/or an image that has been obtained a predefined time interval ago. For the last case, wherein the provided image has been obtained a predefined time interval ago, the predefined time interval may be selected to compensate for delays in the system. The delays in the system may for example comprise or consist of the time that it takes between obtaining an image until the scanning indicator has been formed.

In a further embodiment of the present disclosure, the method comprises a step of repeating, a number of times, the steps of displacing the sample relative to the measurement unit, obtaining an additional image, forming a scanning sequence, analyzing said scanning sequence, and providing the scanning indicator and an image of the scanning sequence. It is a preference that the method comprises repeating of the steps so that the scanning sequence is continuously updated, for example by replacing the oldest obtained image with the most recent obtained image, and analyze the updated scanning sequence for deriving an updated scanning indicator that is provided, such as provided to a user carrying out the method. In this way, the method may be used to continuously detect and species classify biological particles, for example mold spores, in a sample.

Obtaining Scanning Sequence

In an embodiment of the present disclosure the scanning sequence comprises or consists of a predetermined number of the most recently obtained images. For example in a particular embodiment of the present disclosure, the process for obtaining an additional image may be repeated such that multiple images of the sample are obtained. It should be noted that the additional image may be obtained from an area that immediately borders or partially overlaps with the previous imaged area. Alternatively or additionally, the additional image may be obtained by imaging of an area that is separated a distance from the most recently imaged area. Obtaining images of areas of the samples that are separated a distance may, in specific embodiments of the present disclosure, be used in order to guide a controller, e.g. a user or a system, to an area with higher likeliness of presence of biological particles, such as mold. The controller may be provided with a scanning indicator comprising a directional indicator of a direction in which there is an increased likeliness of presence of biological particles, such as mold.

In specific examples, it is however a preference that each consecutively obtained image is at least partly overlapping. Thereby, at least two images have been obtained. It is a further preference that the multiple images are used to form a scanning sequence comprising multiple recently obtained images. The scanning sequence may in specific examples comprise a predefined number of recently obtained images, such as 2, or 3, or 4, or 5, or 6, or 7, or 8, or 9, or about 10, or about 15, or about 20, or about 30, or about 40, or about 50, or about 60, or about 70, or about 80, or about 90, or about 100, or more than 100 images. However, as disclosed elsewhere herein, the number of images of the scanning sequence may be continuously adjusted, preferably automatically, typically by the scanning indicator. It should be noted that the scanning sequence may be formed by the measurement unit, such as formed on a memory of the measurement unit. However, in an alternative embodiment, the scanning sequence is formed by a separate computational unit, such as the remote server. For a configuration wherein the remote server forms the scanning sequence, one, or only a few images, may each time be transmitted to the remote server from the measurement unit. For example, each time an image is obtained by the measurement unit, it may be transmitted to the remote server, such as substantially in real-time. In other embodiments of the present disclosure, the measurement unit may be configured to form the scanning sequence before submitting the scanning sequence to the remote server. For example the measurement unit may replace the oldest obtained images of the scanning sequence with the most recently obtained image. Further, the images of the scanning sequence may be arranged in a particular order. In a specific embodiment of the present disclosure, the scanning indicator is formed by the measurement unit, for such a configuration both the formation of the scanning sequence and the processing thereof may be carried out by the measurement unit. Consequently, the measurement unit may be configured to continuously form the scanning sequence and further to continuously process said scanning sequence.

In a preferred embodiment of the present disclosure, the number of images of the scanning sequence is continuously and automatically adjusted, such as for each repetition of the method, e.g. of steps b-f. Said number of images may for example depend on a predicted probability of detecting biological particles, i.e. of the scanning indicator. Said predicted probability may thereby be considered to reflect the probability of identifying biological particles, such as mold, in the sample as a whole, or in the present field of view, i.e. the area of the sample most recently imaged by the measurement unit. As such, the generated scanning indicator may determine the number of images of the scanning sequence upon repeating the method. A higher probability of identifying biological particles, such as mold, may result in a scanning sequence comprising a higher number of images than for a lower probability for the presence of biological particles. Said probability may, for each repetition of the method, be calculated by a new scanning indicator. Alternatively or additionally, the variation in the number of images of the scanning sequence may depend on sampling factors, including how and where the sample was obtained. For example, the sampling factors may comprise the location of from where the sample was obtained. Certain locations are expected to be associated with a higher prevalence of biological particles, such as mold. For example on horizontal surfaces, such as the top of a baseboard, in wet environments such as a bathroom, areas of high circulation, such as near a ventilation duct. The location information is preferably used, to modify the number of images of the scanning sequence. Typically, samples obtained from locations associated with a high prevalence of biological particles, such as mold, have a scanning sequence with a higher number of images, while locations that are associated with a low prevalence of biological particles, such as mold, have a scanning sequence with a lower number of images. The number of images of the scanning sequence may, alternatively or additionally, be modified, preferably continuously and automatically, by the scanning indicator.

In an embodiment of the present disclosure, the method comprises a step of providing the scanning indicator and an image of the scanning sequence, such as the last image, between step e and f, in this embodiment it is a preference that the step of repeating comprises the repetition of said step of providing.

In a further embodiment of the present disclosure the subsequently obtained images of the scanning sequence are obtained from, at least in part, overlapping parts of the sample. The method may benefit from continuously obtaining images of the sample, wherein the images at least partly overlap. For example, under specific instances it may even be disadvantageous if the obtained images are from separate areas of the sample. By continuously obtaining images of the sample, where said process is configured such that at least a part, or all images, at least partly overlap, a more reliable result may in the end be obtained. A more reliable result due to said overlapping or at least partly overlapping images, may be enabled by obtaining multiple images of the same features under various conditions, such as multiple distances, magnification levels, brightness and contrast conditions, and other scanning conditions such as the scan speed and the stability of the measurement unit. This may ensure a more accurate and/or precise processing of the features in the image, and as a result, a more reliable measurement result may be obtained. This may further be a result of continuously providing the scanning indicator, such as to a user of the measurement unit. It may be a preference that the scanning indicator comprises or consists of relatively recently obtained images, for example images obtained within the last 5 s, such as within the last 4 seconds, such as within the last 3 seconds, such as within the last 2 seconds, such as within the last 1 second, such as within the last 0.5 s, such as within the last 0.1 s. By having a shorter range of acquisition times of the images of the scanning sequence, the scanning indicator will be more representative of the more recently obtained images. However, at the same time it may be a preference to have a sufficient number of images in the scanning sequence in order to enable more accurate processing of the scanning sequence. It should therefore be noted that the number of images of the scanning sequence may be a predetermined number based on the scanning rate i.e. the number of images obtained per second, and further based on the speed by which the measurement unit scans over the sample. For example a slower scan speed, and/or a higher scan rate, typically requires and/or enables, a higher number of images of the scanning sequence. Similarly, a faster scan speed and/or a lower scan rate typically requires/enables a lower number of images of the scanning sequence. The images of the scanning sequence may be individually analyzed, such as for detection and species classification of biological particles, for example mold spores, and or scanning conditions. Following said analysis a mathematical operation may be carried out on said analysis for obtaining a scanning indicator. For example all the images of the scanning sequence is preferably analyzed by the machine learning model. The results of said image analysis may be further processed, for example by a suitable mathematical operation in order to derive a scanning indicator. In a specific embodiment of the present disclosure, an average function is applied to the results of said image analysis. Thereby, the scanning indicator may comprise or consist of the most prominent features, such as the most abundant species classification of the biological particles, for example mold spores, such as in the images of the scanning sequence.

As discussed elsewhere herein the number of images of the scanning sequence may in specific embodiments of the present disclosure be predetermined. Furthermore, the number of images of the scanning sequence may be selected such that the scanning sequence represents only recently obtained images. In a specific embodiment of the present disclosure, the number of images of the scanning sequence may be continuously modified during measurement, preferably automatically. For example the number of images of the scanning sequence may be updated based on the scanning indicator. A sample having a high density of biological particles, for example mold spores, per surface area, and/or a high number of different types of biological particles, for example mold spores, benefit from having a scanning sequence comprising a smaller number of images as the prediction of mold presence is more accurate.

The number of images of the scanning sequence may further be determined by scanning conditions, such as the scan rate, i.e. the rate by which additional images are obtained, and the scan speed, i.e. the speed by which the surface of the sample is scanned, such as the relative speed of the measurement unit and the sample. In a specific embodiment of the present disclosure, the number of images of the scanning sequence is selected such that it is expected to occur at least one fluctuation in the scanning condition, preferably at least two fluctuations in the scanning condition, more preferably at least three fluctuations in the scanning condition. The fluctuations in the scanning condition may be random and/or periodic. For example, for the specific scanning condition of lighting, at least light flickering may be considered periodic, such as when for example using an incandescent light bulb connected to the power grid, e.g. 50 Hz AC. Other fluctuations may be random, such as shakiness of the hand, for instance wherein the measurement unit is held by a user during use. However it may be a preference that the most important fluctuations are expected to occur multiple times in the scanning sequence, in order to avoid large statistical variances between the processing results of multiple scanning sequences, obtained close in time.

In a specific embodiment of the present disclosure the scanning sequence comprises or consists of a dynamic number of obtained images. The number of images of the scanning sequence may thereby continuously be adjusted. Preferably the number of images of the scanning sequence is determined by the results of analysis of the scanning sequence, typically the scanning indicator and/or condition. It should be noted that the scanning indicator may comprise information of the scanning condition. For example if any of the scanning conditions are too high or too low for obtaining accurate results, the number of images of the scanning sequence may be adjusted in order to compensate for said too high or too low conditions. For example a too high scanning speed together with a too low scanning rate would result in scanning indicators not representative of the presently imaged area, or an area nearby. The scanning indicator may in this specific example comprise an alert to decrease the scan speed.

In a specific embodiment of the present disclosure, the images are obtained at a rate of at least 10 images per second, i.e. the scan rate. As discussed elsewhere herein the scan rate may be dependent on other factors such as the scan speed and the number of images of the scanning sequence. Thereby, for specific embodiments of the present disclosure, the scan rate is at least 20 images per second, such as at least 30 images per second, such as at least 40 images per second, such as at least 50 images per second, such as at least 60 images per second, such as at least 70 images per second, such as at least 90 images per second, such as at least 100 images per second.

In a further embodiment of the present disclosure, the scan rate is less than 100 images per second, such as less than 90 images per second, such as less than 80 images per second, such as less than 70 images per second, such as less than 60 images per second, such as less than 50 images per second, such as less than 40 images per second, such as less than 30 images per second, such as less than 20 images per second, such as less than 10 images per second.

In an embodiment of the present disclosure the recently obtained images are obtained within a short time of forming the scanning sequence. For example within five seconds of forming the scanning sequence, such as within four seconds of forming the scanning sequence, such as within three seconds of forming the scanning sequence, such as within two seconds of forming the scanning sequence, such as within one seconds of forming the scanning sequence, such as within half a second of forming the scanning sequence, such as within a tenth of a second of forming the scanning sequence, such as within a hundredth second of forming the scanning sequence.

Mold Spores Type

In a specific embodiment of the present disclosure, the mold spores may be any type of mold species. In a further embodiment of the present disclosure, the mold spores may be any type of fungi species. In a specific embodiment of the present disclosure the mold spores belongs to any of the following genera: Acremonium, Aureobasidium, Alternaria, Aspergillus, Botrytis, Chaetomium, Cladosporium, Epicoccum, Eurotium, Fusarium, Geotrichum, Monilia, Manoscus, Mortierella, Mucor, Neurospora, Oidium, Oospora, Penicillium, Rhizopus, Stachybotrys, Thamnidium, Trichoderma, Trichothecium, Trichophyton, and/or Wallemia.

The biological particles, for example mold spores, may be a species that is typically found in the environment, for example an indoor environment, and/or the biological particles, for example mold spores, may be a species that is typically found in food products, such as dairy products.

MAI Algorithm

In a specific embodiment of the present disclosure, the machine learning algorithm is any type of machine learning model. In a further embodiment of the present disclosure the machine learning model is a convolutional neural network.

In an embodiment of the present disclosure the machine learning model has been trained by supervised learning, unsupervised learning and/or a combination thereof.

In an embodiment of the present disclosure the machine learning model has been trained using labelled training data. The labelled training data preferably comprises or consists of images of verified samples (e.g. wherein the species of the biological particles, for example mold spores, have been verified) and/or wherein the scanning conditions are known. Consequently the labels of said training data may comprise or consist of one or more species, such as one or more species present in a specific image, and/or parameters of the scanning condition.

In an embodiment of the present disclosure the labelled training data comprises or consists of DNA verified and/or expert labelled samples of biological particles, for example mold spores.

Training of the Machine Learning Algorithm

The machine learning algorithm may for example be a Convolutional Neural Network (CNN). In one embodiment of the present disclosure, the machine learning algorithm or machine learning model is at least partly designed through transfer learning from a pre-trained model. For example a model utilizing an available dataset, such as the ImageNet dataset, and/or partly through the introduction of a DNA-verified dataset. Preferably the DNA-verified training set/dataset comprises a high number of images, for example at least 1,000 images, or more preferably at least 8,000 images from eight different representative mold species. The latter part may define the last layers of the CNN model, including the Softmax Activation function, to classify any input images as any of the eight mold species.

Several image processing steps may be taken to train the last layers of the CNN model. The steps may for example include (i) down-sampling of the images to a generic dimension of 224×224; (ii) boosting the pool of DNA-verified mold images by means of, e.g., flipping the images left to right and up to down; and (iii) light enhancement of the image through a methodology that borrows from Histogram equalization.

In an example, the training of the machine learning model comprised a benchmarking training phase (BTH). This training phase was conducted to yield an objective estimate of the scanning procedure requirements in order for the machine learning model to correctly predict the presence of biological particles. The training comprised acquisition of a large number of samples, from various locations, mainly by tape sampling. In the BTH, multiple samples (at least 50, but often at least 100) were extracted from locations with a corresponding MycoMeter Surface Fungi (MSF) test. However, for the present disclosure, any accurate reference test may be used. For each sample, the surface was scanned using a measurement unit and an x-y table to move the sample, resulting in a number of scanning indicators, wherein said number corresponded to the number of images obtained and the portion of the sample surface covered. A linear regression analysis was conducted between the gathered probabilities of the resulting scanning indicators and the MSF test results. A threshold value for the number of scanning indicators and the corresponding portion of the sample surface required to correctly predict the presence of mold was extracted based on the MSF result. In specific embodiments of the method for continuous detection and species classification of the present disclosure, said threshold value is used to set a minimum number of repeats, for scanning a sample. The method, in this example, comprised repeating, a number of times equal to said threshold value. Thereby the required number of scanning indicators and/or the required portion of the sample surface covered can be covered to correctly predict the presence of biological particles, e.g. mold. Repeating may thereby involve, repeating, with a minimum number of times, step b-f, such that the result represents the whole sample. The minimum amount of repetitions may be computed from a posteriori threshold value derived from benchmarking the scanning indicator with a verified test that quantifies mold on surfaces.

Analysis

The scanning sequence is analyzed for the presence of biological particles, such as hazardous biological particles and/or mold. The analysis is typically performed by a trained machine learning model, such as a convolutional neural network model. In a preferred embodiment of the present disclosure, the scanning sequence, comprising multiple recently obtained images, is analyzed by the machine learning model. The analysis by the machine learning model preferably results in the generation of a scanning indicator. The method is preferably adapted such that the scanning sequence comprises the most recently obtained images, thereby, for each repetition of the method, a newly obtained image may replace the oldest image in the scanning sequence. The scanning indicator typically comprises at least an estimate of the presence of biological particles in the sample. In specific examples, as described elsewhere herein, the scanning indicator may comprise information that a controller, e.g. a user and/or a system, may use in order to optimize the scanning conditions, such as the focus, the lighting, the scanning speed and/or the scanning direction. The controller (control unit or control system) may for example be a system comprising a motorized stage and computing means. The control unit may be arranged to, based on the scanning indicator, control the position of the sample relative to the measurement unit. For example, the scanning indicator may comprise direction indicators providing a direction of the sample that is likely to have biological particles, such as mold. The scanning indicator may thereby be provided to the control unit that is configured to control the position of the sample relative to the measurement unit, such that an area with high probability of having biological particles is imaged.

In other embodiments of the present disclosure, the machine learning model may perform an initial separate analysis of each image of the scanning sequence. The results of said analyses may be used to form the scanning indicator. For example the scanning indicator may be formed by an average operation of all the images of the scanning sequence. separately In an embodiment of the present disclosure the scanning indicator comprises or consists of an average of the analysis of each image of the scanning sequence.

In an embodiment of the present disclosure each image of the scanning sequence has been given a specific weight. Consequently, the formation of the scanning indicator may, at least in part, be based on a weighted average function.

In an embodiment of the present disclosure the scanning indicator is formed by applying an average function to the analysis results of the scanning sequence. It is a preference that the scanning sequence is continuously updated, for example wherein the last obtained image replaces the oldest obtained image of the scanning sequence. Thereby, the scanning indicator may be formed by a moving average function. In a particular embodiment of the present disclosure, the scanning indicator is formed by the application of an average function to the result of analysis of each image of the scanning sequence. Preferably, each image of the scanning sequence is analyzed by a machine learning model, and following said analysis, a mathematical function is applied to the results for formation of the scanning indicator. The scanning indicator may thereby be said to be formed according to a moving average. However, in another embodiment of the present disclosure, the mathematical function applied to the results of the analysis by for example the machine learning model, of each image of the scanning sequence, may be another mathematical operation. For example a weighted average.

Scanning Indicator

In an embodiment of the present disclosure the scanning indicator is obtained and/or provided to a user or a system controlling the measurement unit substantially in real-time. It is consequently a preference that the time between obtaining an image, and deriving a scanning indicator from a scanning sequence comprising said image is substantially in real-time. The time between formation of an updated scanning indicator from the time of obtaining an image, may in part be dependent on the processing power of the system. Therefore, the system may be configured for communication with a remote server. In such instances the speed of the system may be dependent, at least, on the speed of the communication between the measurement unit and the remote server. It is however a preference that the delay time, between obtaining a new image and forming a scanning indicator based on a scanning sequence comprising said obtained image is as low as possible. A lower delay time may result in more accurate and precise feedback, such as to a user of the measurement unit, and in turn more reliable measurements. It is a further preference that the display delay time is as low as possible, such as the time between forming a scanning indicator to providing said scanning indicator, such as to a user of the measurement unit.

In an embodiment of the present disclosure the scanning indicator is provided together with the recently obtained image, such as the last obtained image. The scanning indicator is preferably provided at the same time as the obtained image, such as a recently obtained image. The recently obtained image is preferably an image of the scanning sequence, and consequently the recently obtained image has been used for formation of the scanning indicator. In a particular embodiment of the present disclosure, the recently obtained image is the most recently obtained image or the last obtained image.

In an embodiment of the present disclosure the scanning indicator comprises a classification of the biological particles, for example mold spores. The classification of the biological particles, for example mold spores, may be according to one or more taxonomy levels, for example the species and genus. Furthermore, the scanning indicator may comprise the most abundant biological particle species, for example mold spores, or only the most abundant biological particle species. Furthermore, the scanning indicator may comprise information related to the scanning conditions. The scanning conditions may be the conditions under which the images were obtained. The scanning conditions may for example be or be related to the lighting conditions, the scan rate, the scan speed, the image quality, the zoom level, the magnification level, the contrast level, the brightness level, the focus level, or a combination thereof. Preferably, the scanning conditions comprise any factor that may affect the ability of the measurement unit to obtain an accurate image of the sample.

In an embodiment of the present disclosure the scanning indicator comprises a significance level of the classification. In a further embodiment of the present disclosure, the machine learning model may be configured to provide a prediction of the accuracy of the results provided by said machine learning model. For example, related to the species classification of biological particles, the machine learning model may provide an indication of the accuracy of the prediction that the scanning sequence comprises a specific species of biological particles.

In an embodiment of the present disclosure, the scanning indicator comprises a sample scan fraction value, that is a value of the portion of the sample that has been scanned, i.e. imaged and/or analyzed. Typically, the scanning indicator comprises said value as a percentage of the entire sample. As disclosed elsewhere herein, the training phase, for training the machine learning model, may comprise a benchmark phase, wherein it is determined the fraction of the sample and/or the number of scanning indicators required in order to derive an accurate prediction of the presence of biological particles. Therefore, the scanning indicator may comprise the sample scan fraction value together with said required fraction of the sample, to the controller, e.g. user and/or machine, who continues to scan the sample until the sample scan fraction value reaches said required fraction of the sample.

In an embodiment of the present disclosure the scanning indicator is provided as a text and/or color coding, such as a color coded symbol, such wherein the color coding represents a significant level of the results provided in the scanning indicator. For example the predicted accuracy of the scanning indicator. In a further embodiment of the present disclosure, the scanning indicator is provided in visible, audible and/or tactile form.

In an embodiment of the present disclosure the recently obtained image is the most recently obtained image. However in further embodiments the recently obtained image may be any other image, for example an image of the scanning sequence, such as the image obtained at an average time point, of the images of the scanning sequence. Furthermore, the recently obtained image may be an image that is not part of the scanning sequence, for example the recently obtained image may be obtained more recent, that any of the images of the scanning sequence, or the recently obtained image may be taken at a time point between the time points of obtaining two images of the scanning sequence, or the recently obtained image may have been obtained at an earlier time point than any of the images of the scanning sequence.

In an embodiment of the present disclosure the scanning indicator comprises the species of the biological particles that is most abundant in the scanning sequence. In a further embodiment of the present disclosure, the scanning indicator comprises only the species of the biological particle species that are the most abundant in the scanning sequence.

In an embodiment of the present disclosure the scanning indicator comprises multiple biological particle species. The scanning indicator may comprise an indication of the abundance of each biological particle species. For example, the number of images wherein said biological particle species is present, and/or the number of biological particle species present in each and/or all images.

In an embodiment of the present disclosure the scanning indicator comprises an indication of an area, e.g. an area indication, in the recently obtained image comprising biological particles, such as a colored overlay. Said area indication may thereby provide information related to the area in the provided image, for example the recently obtained image, wherein one or more biological particles have been identified. Furthermore, when the scanning indicator comprises a colored overlay, the accuracy of the prediction may be provided as part of the colored overlay, for example based on the color of said colored overlay.

In an embodiment of the present disclosure the scanning indicator comprises a direction indicator, such as an arrow, indicating a direction to an area likely to comprise biological particles, such as mold spores. The area likely to comprise biological particles may have been identified based on analysis of the perimeter of the image. For example, if the machine learning model identifies that the perimeter of the images of the scanning sequence (e.g. the average of the images of the scanning sequence) comprises what is likely to be biological particles, a scanning indicator comprising a direction indicator may be included in the scanning indicator. Thereby the scanning indicator may provide information that the region of interest, i.e. the area of the surface visible in the obtained image, is displaced in the direction of where the presence of biological particles have been identified as likely.

In an embodiment of the present disclosure the scanning indicator comprises a number of indicators of the scanning condition, such as a lightning level, a scanning speed, a focus level, a background particle level, the scan rate, the scan speed, the contrast level, the brightness level and/or a background contrast level. It is a preference that the indicators indicate if any of the parameters of the scanning condition is too high or too low, for acquisition of representative images of the sample and/or for acquisition of images from which an accurate scanning indication can be formed. For example it is a preference that the scanning indicator comprises information of whether the images are obtained with a too fast scan speed, i.e. a user of the measurement unit displaces said measurement unit too fast, or not. Furthermore, it is a preference that the scanning indicator comprises information of whether there are any factors of the sample that affects the quality of the obtained images and/or the ability to produce an accurate scanning indicator based on the obtained images. For example if the number of background particles are too high, and/or if the number of particles per area unit is too high.

In an embodiment of the present disclosure the method further comprises compiling of a measurement result, said compiling may comprise or consist of applying a mathematical operation to all scanning indicators formed during scanning of the at least a part of the sample. For example the measurement result may be a time-average of all scanning indicators during the scanning of the at least a part of the sample.

Sample

In an embodiment of the present disclosure the sample is a food product, such as a dairy product, and/or a collection of particles obtained from a surface or extracted from a volume of air.

In a specific embodiment of the present disclosure, the sample has not been obtained by sample collection.

In an embodiment of the present disclosure the step of providing the sample comprises or consists of collecting of the sample, such as by tape sampling and/or air sampling.

In an embodiment of the present disclosure the sample has been obtained from a surface, such as by tape sampling, or from the air, such as air sampling.

In an embodiment of the present disclosure the sample comprises a tape, for sampling of biological particles, such as a tape adhered to a slide (e.g. glass or plastic). In specific embodiments of the present disclosure, the machine learning algorithm is trained under specific conditions and/or with specific types of samples. In such instances, the method for detection and species classification of biological particles, such as mold, is preferably carried out at the same conditions and/or with the same types of samples as during the training stage. These conditions include the scanning conditions

Tape sampling is the most common technique used to test surfaces for biological particles, such as mold. This method can be performed using either standard, clear cellophane tape or tape and tape kits specifically designed for biological particle sampling. Both types involve sampling by direct contact, typically to areas of visible biological particles, however areas wherein no biological particle is present may also be sampled, for example for collecting of mold spores. Typically, the tape or a slide prepared with adhesive is pressed against a surface in order to collect the sample, which is subsequently analyzed.

Another method that may be used for sample collection, alternatively or additionally to tape sampling, is air sampling. Mold spores, for example, are not visible to the naked eye, and the types of mold present can often be determined through laboratory analysis of the air samples. Having samples analyzed can also help provide evidence of the scope and severity of a mold problem, as well as aid in assessing human exposure to mold spores. After remediation, new samples are typically taken to help ensure that all mold has been successfully removed. Air samples can be used to gather data about mold spores present in the interior of a house. These samples may for example be provided by using a pump that forces air through a collection device which catches biological particles, such as mold spores, for example by a filter unit. Typical air sampling device include impaction samplers that use a calibrated air pump to impact spores onto a prepared microscope slide; cassette samplers, which may be of the disposable or one-time-use type, and also employ forced air to impact spores onto a collection media; and airborne-particle collectors that trap spores directly on a culture dish. These are typically utilized to identify the species of biological particles, such as mold that has been found. Alternatively or additionally, air samples may be provided by the use of collection media plates, such as agar plates. These plates may be used during sampling by positioning said plates in an environment, such as an indoor environment, for a specific amount of time, for example a few hours. Airborne biological particles, such as mold spores, may settle on the collection media plate, and may be cultivated for a suitable amount of time. Typically, biological particles, such as mold spores, may be cultivated for a few days. Following cultivation of the air-sampled biological particles on a collection media plate, images may be obtained either directly of any formed colonies, or tape sampling may be carried out on any formed colonies prior to imaging of said tape samples.

Measurement Unit

In an embodiment of the present disclosure the measurement unit comprises an image acquisition device, for example an image sensor. Preferably said image acquisition unit comprises a memory, a processing unit, and/or electrical wiring.

In a further embodiment of the present disclosure the measurement unit comprises at least one display unit, such as for providing the recently obtained image and/or the scanning indicator.

In an embodiment of the present disclosure the measurement unit is portable. It may be a preference that the measurement unit is configured such that it can be moved around. For example in cases wherein the sample is not able to be provided to the measurement unit. A typical example may be wherein the measurement unit is configured for direct analysis of biological particles, such as mold spores, present on a surface, i.e. without a separate step of collecting the sample. For example by directly obtaining images of one or more surfaces, such as surfaces of a building or a product, such as a food product.

In a specific embodiment of the present disclosure, the measurement unit is a smartphone. Preferably the measurement unit, such as the smartphone, is configured to carry out the method for continuous detection and species classification of biological particles in a sample. The measurement unit, such as the smartphone, may for example comprise programming code, e.g. stored on a memory, such a non-transient memory, that when executed performs at least a part of the method for continuous detection and species classification of biological particles in a sample, as disclosed herein. Preferably the measurement unit, such as the smartphone, is configured to obtain an image and/or additional images, such as an additional image and/or any further images. The measurement unit, such as the smartphone, is preferably further configured to form a scanning sequence, such as continuously form scanning sequences, preferably based on one or more obtained images, and preferably form said scanning sequence following obtaining one or more additional images. The measurement unit, such as the smartphone, is preferably further configured to analyze said scanning sequence for the presence of biological particles, for example by a machine learning model. The analysis may comprise individual analysis of each image of the scanning sequence, and the compilation of a result thereof, such as an average. Preferably the measurement unit, such as the smartphone, is further configured to display a scanning indicator, said scanning indicator may at least in part comprise information obtained from the scanning sequence, such as said analysis and compiling thereof. Preferably, the measurement unit, such as the smartphone, is configured to repeat the method, thereby allowing for continuous detection and species classification of biological particles in a sample.

In an embodiment of the present disclosure the measurement unit and/or the sample is fixed in position. Consequently, at least one of the measurement unit and the sample may be fixed in position, while the other may be displaced. Thereby allowing for scanning of the sample, such as the surface of the sample. However, it should be noted that although both the measurement unit and the sample is fixed in position, scanning of the sample could be carried out by angling, tilting and/or rotating of either the measurement unit and/or the sample. Further, for instance wherein both the measurement unit and the sample are fixed in position the sample may be scanned by angling, tilting and/or rotating of either the measurement unit and/or the sample. It may consequently not be essential, although in preferred in specific embodiments of the present disclosure,

In an embodiment of the present disclosure the sample is displaced at a constant speed and in a constant direction, such as a production line, for example of a food product, such as a dairy product.

Remote Server

In an embodiment of the present disclosure the measurement unit comprises means for communication with a remote server. The measurement unit may for example comprise means for communication over a network, such as a telecommunication, for example 4G LTE. The measurement unit may be configured to communicate with the remote server through other communication units, such as base stations, servers, repeaters or other units of a network, such as a telecommunications network.

In an embodiment of the present disclosure the measurement unit is configured for transferring obtained images to the remote server and/or for transferring the scanning sequence to the remote server. The measurement unit and the remote server may be configured such that the scanning sequence is formed by the measurement unit, before transmitting said scanning sequence to the remote server, or be configured such that the obtained image is transmitted to the remote server, and wherein the remote server is configured to form the scanning sequence (e.g. by replacing the oldest obtained image of the scanning sequence with the most recently obtained image).

By having a measurement unit configured for transferring obtained images, such as

In an embodiment of the present disclosure the measurement unit is configured for receiving, from the remote server, the scanning indicator, such as substantially in real time. For example in instances wherein the remote server has analyzed the scanning sequence and formed a scanning indicator, the remote server and the measurement unit may be configured to transmit and receive the formed scanning indicator respectively in a further embodiment of the present disclosure, the measurement unit and the remote server may be configured to transmit and receive the scanning sequence and/or an obtained image respectively.

In an embodiment of the present disclosure the analysis of the scanning sequence, such as for formation of a scanning indicator, is performed on the measurement unit and/or the remote server.

A Measurement Unit

In a second aspect, the present disclosure relates to a measurement unit for continuous detection and species classification of biological particles in a sample. It is a preference that the measurement unit is configured for continuous detection and classification. Continuous detection may be enabled by having a measurement unit that is configured for continuously processing obtained images in a suitable manner, locally or by a remote server, and thereafter continuously providing the results of said processing, such as to a user of said measurement unit. In a specific embodiment of the present disclosure the classification comprises species classification, however the classification may comprise any levels of the taxonomy, for example species, genus, family, order, class, phylum, kingdom, and/or domain. The classification may in a specific embodiment comprise or consist of the strain. It is a preference that the method comprises continuous scanning of a part of a sample. Preferably said part of the sample comprises or consists of a surface, but said part may in a specific embodiment of the present disclosure be a volumetric part of the sample. It is a further preference that the method comprises scanning along at least a part of the sample. The scanning may thereby be a two-dimensional and/or three-dimensional scanning of the surface. A three-dimensional scan is typically obtained by acquisition of multiple two-dimensional images in planes that are substantially orthogonal to the scanning direction.

In a further embodiment of the present disclosure, the measurement unit is configured for continuously scanning a sample, such as a part of the sample and/or along at least a part of the sample.

In yet a further embodiment of the present disclosure, the measurement unit is configured for continuous scanning comprising obtaining an image of a part of said sample.

In yet a further embodiment of the present disclosure, the measurement unit is configured for continuous scanning comprising displacing the sample relative to the measurement unit. Displacing as used herein refers to any, or multiple, of spatial translation, angling, tilting and/or rotating. Thereby, the measurement unit and/or the sample may be spatially translated, angled, tilted and/or rotated for the continuous scanning.

In yet a further embodiment of the present disclosure, the measurement unit is configured for continuous scanning comprising obtaining an additional image of an additional part of said sample, such as by the measurement unit, and wherein said additional image overlapping at least in part with a last obtained image.

In yet a further embodiment of the present disclosure, the measurement unit is configured for continuous scanning comprising forming a scanning sequence comprising multiple recently obtained images.

In yet a further embodiment of the present disclosure, the measurement unit is configured for continuous scanning comprising analyzing said scanning sequence for the presence of said biological particles, such as mold spores, by a trained machine learning model, such as a convolutional neural network model, thereby obtaining a scanning indicator.

In yet a further embodiment of the present disclosure, the measurement unit is configured for continuous scanning comprising providing the scanning indicator and an image of the scanning sequence, such as the last image.

In yet a further embodiment of the present disclosure, the measurement unit is configured for continuous scanning comprising repeating, a number of times, the steps of displacing the sample, obtaining an additional image, forming a scanning sequence, analyzing said scanning sequence, and/or providing the scanning indicator.

In yet an embodiment of the present disclosure the measurement unit is configured for carrying out the method according to the method for continuous detection and species classification of biological particles in a sample as disclosed elsewhere herein.

A System

In a third aspect, the present disclosure relates to a system for continuous detection and species classification of biological particles in a sample. It is a preference that the system is configured for continuous detection and classification. Continuous detection may be enabled by having a system that is configured for continuously processing obtained images in a suitable manner, locally and/or by a remote server, and thereafter continuously providing the results of said processing, such as to a user of a measurement unit.

In a particular embodiment of the present disclosure, the system for continuous detection and species classification of biological particles in a sample comprises a measurement unit configured for scanning at least a part of the sample, such that a number of images along at least a part of said sample is obtained.

In a particular embodiment of the present disclosure, the system for continuous detection and species classification of biological particles in a sample comprises a measurement unit configured for transferring the obtained images to a remote server.

In a particular embodiment of the present disclosure, the system for continuous detection and species classification of biological particles in a sample comprises a measurement unit configured for providing an image of the scanning sequence and/or the scanning indicator.

In a particular embodiment of the present disclosure, the system for continuous detection and species classification of biological particles in a sample comprises a measurement unit configured for repeating, a number of times the steps obtaining an image, i.e. by scanning a surface of the sample, transferring of an obtained image to a remote server, providing, such as providing of a recently obtained image, such as an image of the scanning sequence, and/or a scanning indicator.

In a particular embodiment of the present disclosure, the system for continuous detection and species classification of biological particles in a sample comprises a remote server configured for receiving a number of obtained images, such as a number of obtained images of a measurement unit, such as transmitted images.

In a particular embodiment of the present disclosure, the system for continuous detection and species classification of biological particles in a sample comprises a remote server configured for forming a scanning sequence comprising multiple recently received images.

In a particular embodiment of the present disclosure, the system for continuous detection and species classification of biological particles in a sample comprises a remote server configured for analyzing said scanning sequence. Such as for the presence of biological particles and/or biological particle species classification, for example by a trained machine learning model, such as a convolutional neural network model. It is a preference that the analysis is used to obtain a scanning indicator. Thereby, the scanning indicator may comprise said analysis results

In a particular embodiment of the present disclosure, the system for continuous detection and species classification of biological particles in a sample comprises a remote server configured for transferring the scanning indicator to the measurement unit.

In an embodiment of the present disclosure the system is configured for carrying out the method for continuous detection and species classification of biological particles in a sample as disclosed elsewhere herein.

In an embodiment of the present disclosure the measurement unit is configured according to the measurement for continuous detection and species classification of biological particles in a sample as disclosed elsewhere herein.

In a fourth aspect, the present disclosure relates to training of a machine learning model for continuous detection and species classification of biological particles in a sample. The method comprising obtaining a labelled training set, such as images of expert labelled and/or DNA verified samples; and training the machine learning model by said training set.

### DETAILED DESCRIPTION OF DRAWINGS

The invention will in the following be described in greater detail with reference to the accompanying drawings. The drawings are exemplary and are intended to illustrate some of the features of the presently disclosed method, measurement unit or system for continuous detection and species classification of biological particles in a sample, and are not to be construed as limiting to the presently disclosed invention.

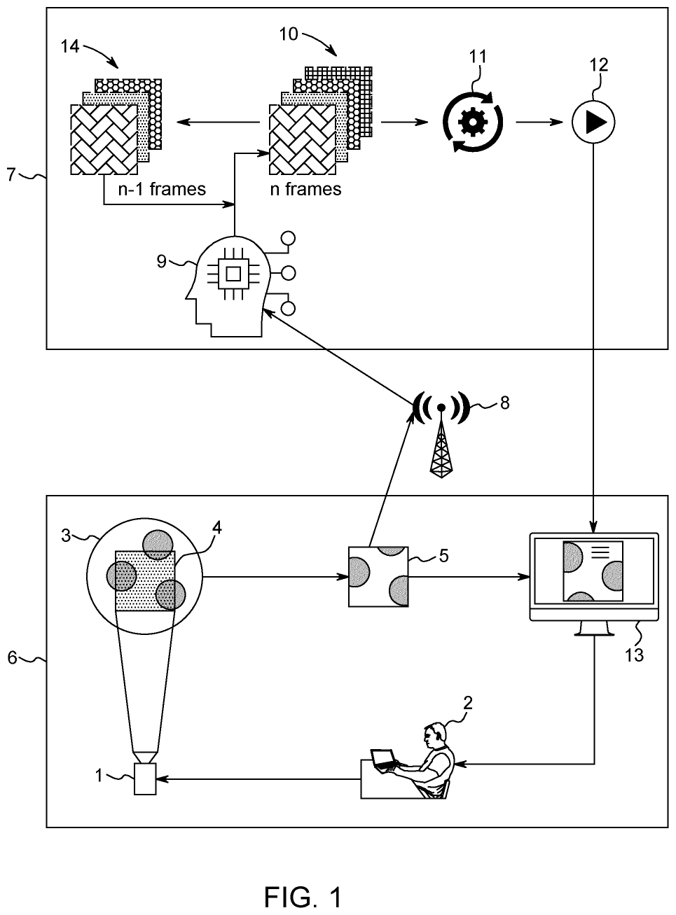

FIG. 1 shows a schematic illustration of a method and a system for continuous detection and species classification of biological particles in a sample, according to a specific embodiment of the present disclosure. A measurement unit (1) that comprises means for acquisition of images, such as an image sensor, is preferably controlled by a user (2). The measurement unit may be hand-held and consequently directly controlled by the user, or may be mounted to a control unit and indirectly controlled by a user, for example the user may control the control unit through a computer interface. Furthermore, the measurement unit may be configured such that the area that is imaged, i.e. the area of which an image is acquired, can be adjusted. Images may be obtained of a sample (3). Typically, the measurement unit may be controlled by a user, wherein the user may control what area of the sample that is imaged (4) by the measurement unit. In a first step, an image (5) may be obtained of an area of the sample. In a specific embodiment, the image is transmitted from the location of the measurement (6) to a remote server (7), for example through a network (8), such as a telecommunication network with a base station. In a specific embodiment of the present disclosure, the measurement unit may comprise means for communicating with a remote server. A configuration of a system, having a measurement unit and a remote server that are configured for communicating with each other, enables several benefits. For example, a remote server may provide an increased computational performance, and wherein the system relies on the use of a machine learning model, the specific model applied for the analysis may be selected based on the specific type of sample that is analyzed. However in other embodiments of the present disclosure, the measurement unit itself may be used to analyze the obtained image. Once the obtained image is present at the analysis unit, such as a remote server, or the measurement unit, the image may be analyzed by a machine learning model (9), such as a convolution neural network. The machine learning model may have been trained to detect and/or classify biological particles, such as mold species, in obtained images. However the machine learning model may be further trained to detect scanning conditions, such as scan rate and lighting conditions. Each subsequent analyzed image may be used to form a scanning sequence. The scanning sequence thereby comprise the results of the analysis of each obtained image, by the machine learning model. Each image of the scanning sequence may, following analysis of the machine learning model, comprise or consist of the analysis results, such as the presence of biological particles and the species thereof, in addition to any other analysis results, such as the scanning conditions. A mathematical algorithm (11) may be used to obtain a scanning indicator (12) from the scanning sequence. The mathematical algorithm may be an average of the scanning sequence. The scanning indicator is thereafter provided to the user. For example, the scanning indicator may be combined with a recently obtained image, such as an image of the scanning sequence, for example the most recently obtained image, and provided to the user. The image and the scanning indicator is provided as feedback (13) to the user. By the feedback, the user of the measurement unit may adjust the measurement, such that reliable detection and species classification of biological particles in a sample can be carried out.

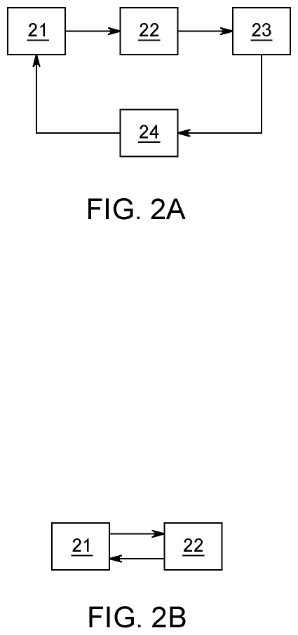

FIG. 2 shows a process for continuous detection and species classification of biological particles in a sample, according to a specific embodiment of the present disclosure. FIG. 2A shows a process wherein a user (21) controls a measurement unit (22). The measurement unit is used to obtain images that are provided to a remote server (23). The remote server performs an analysis of a scanning sequence, formed from recently obtained images. Said analysis is used to form a scanning indicator that is provided back to the user by any suitable instrument (24), for example by a display unit and/or a speaker. The scanning sequence may be formed on the measurement unit before being transmitted to the remote server, or the scanning sequence may be formed on the remote server. FIG. 2B shows an example of a system with a lesser number of separate components, as compared to the previous example. In this exemplary embodiment of the present disclosure a user (21) may control a measurement unit (22) that is configured to obtain images, analyze the obtained image by a machine learning model for detection and biological particle species classification, forming a scanning sequence, applying a mathematical algorithm to the scanning sequence in order to obtain a scanning indicator, and providing said scanning indicator to a user (21). The scanning indicator may be provided in any form, as disclosed elsewhere herein, for example in visual form on a display unit. The scanning indicator may be provided together with a recently obtained image, such as the most recently obtained image of the scanning sequence. The scanning indicator and the recently obtained image may thereby be provided together, such as on the same display unit to the user. The user may, by the provided feedback, adjust the measurement, for example by adjusting the measurement unit, such that a separate area of the sample is imaged, the scan rate, the scanning conditions, and/or the sample, such as obtaining a new sample with a particle density that is more or less than the present particle density.

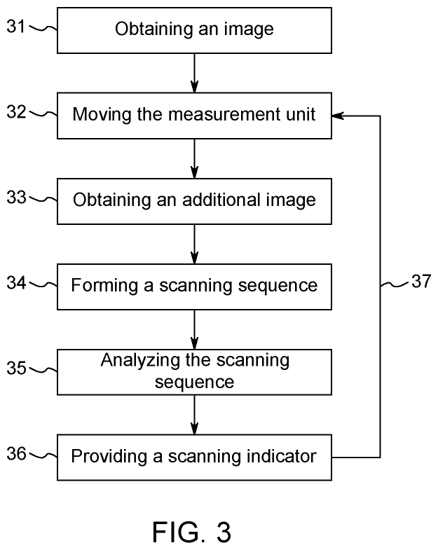

FIG. 3 shows a process for continuous detection and species classification of biological particles in a sample, according to a specific embodiment of the present disclosure. Detection and species classification of mold spores typically begins with obtaining a sample (not shown). The sample may for example be obtained by tape sampling or air sampling. A system, that at least comprises a measurement unit, is used to continuously obtain images (31) of a part of the surface of the sample, the measurement unit may thereby be said to continuously scan, or record a video sequence of a surface of the sample. Following obtaining an image of a part of a surface of the sample, the measurement unit is displaced such that another part of the surface is imaged (32). Typically the measurement unit is displaced relative to the sample, for example spatially translated or angled. The measurement unit thereafter obtains an additional image of the new/additional part of the surface of the sample (33). Preferably the additional part of the surface of the sample at least partly overlaps with the previously imaged part of the sample, e.g. the most recently imaged part of the sample. Depending on the configuration of the system, a scanning sequence is formed (34) either by the measurement unit, e.g. by a processing unit of the measurement unit, or on a remote server, to which the images have been transmitted. The scanning sequence may comprise or consist of the obtained images. Alternatively or additionally, the scanning sequence may comprise the results of analysing each image by a machine learning model. For instances wherein the scanning sequence comprises or consists of the obtained images, the machine learning model may analyze the scanning sequence, i.e. after forming the scanning sequence. In alternative embodiments of the present disclosure, the machine learning model may analyze each obtained image, and the results and/or said obtained image used to form a scanning sequence, with other previously analyzed images. Following formation of a scanning sequence comprising or consists of analyzed images, such as the results from such analysis, the scanning sequence is analyzed for the formation of a scanning indicator (35). This, second analysis, may be carried out by a machine learning model, and may be directed at applying a mathematical algorithm, such as an average, or a weighted average to the results of the analysis of each image of the scanning sequence. For example, each frame or image of the scanning sequence may prior to said secondary analysis comprise or consist of the results from the initial analysis, wherein a machine learning model analyses each obtained image for the detection and species classification of biological particles. The secondary analysis may analyze each parameter separately, for example the biological particles that are present in each obtained image, the lighting conditions of each obtained image, and/or any other of the scanning conditions of each obtained image. A mathematical algorithm, such as an average function or a weighted average function may be applied to each of said parameters resulting in the formation of a scanning indicator. The scanning indicator may thereby comprise several different parameters, obtained from the scanning sequence, such as detected biological particle species, the accuracy of the prediction, the scanning conditions, such as the lighting conditions, the scan rate, e.g. too fast or too slow. The scanning indicator is thereafter provided (36), for example by the measurement unit. Typically, the scanning indicator is provided to a user of the measurement unit, such that the user may move or control the measurement unit (37) such that a most reliable prediction of the detection and/or species classification of the biological particles can be obtained. For example the user may adjust the scanning conditions, including the lighting conditions, the user may adjust what area of the surface of the sample that is imaged, the user may further adjust the scan rate and/or the focus level, or any other parameter of the image acquisition of a surface of the sample such that the prediction of the presence and/or species classification of the biological particles is as reliable, e.g. accurate and precise, as possible.

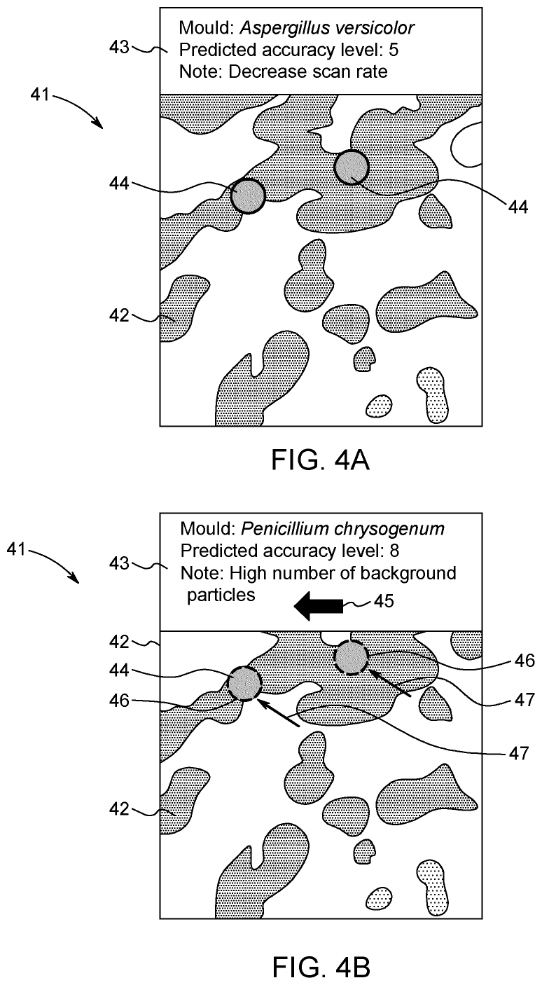

FIG. 4 shows illustrations of feedback in the form of an image of a sample and a scanning indicator, obtained by analysing obtained images, according to a specific embodiment of the present disclosure. The feedback is in both figures provided in visual form, for example to a user. However in other embodiments of the present disclosure, the feedback may be provided by other means, for example audible or tactile, as disclosed elsewhere herein. Furthermore, the image may be provided separate from the scanning indicator, and by separate means. In FIG. 4A the feedback (41) comprises an obtained image (41), for example the most recently obtained image or any other image of the scanning sequence. The feedback further comprises a scanning indicator, that provides specific information obtained from analysis of the scanning sequence, by the machine learning model. For example the biological particles, such as mold, species present, the accuracy of the analysis/prediction and prompts regarding optimization of the scanning conditions, for example if the scan rate is too high, the scanning indicator may comprise a prompt that the scan rate should be decreased, in order to increase the reliability of the analysis, e.g. the accuracy of the detection and species classification of biological particles in the sample. In this specific example, biological particles (44) have been identified as Aspergillus versicolor mold spores. FIG. 4B shows another exemplary feedback (41), comprising an obtained image (42) and a scanning indicator (43). Biological particles (44) in the form of mold spores are present in the obtained image. The scanning indicator in this example comprises an indicator (45), here in the form of an arrow that is used to indicate, for example to a user, an advised scanning direction. The advised scanning direction may be based on an analyzed likeliness of biological particles being present in a specific direction of the surface of the sample, as disclosed elsewhere herein. Furthermore, the feedback comprises an overlay (46) that is used to highlight the area of detected biological particles, here the contour of the biological particles are indicated. Further, the feedback comprises arrows (47) pointing at detected biological particles. As disclosed elsewhere herein, a user may continuously obtain the feedback, and continuously modify the scanning of the surface of the sample, and/or he scanning conditions, such that more reliable detection and species classifications of biological particles can be carried out.

Items
1. A method for continuous detection and species classification of biological particles in a sample, the method comprising continuously scanning along at least a part of the sample, said continuous scanning comprising:
   a. Obtaining an image of a part of said sample, by a measurement unit;
   b. Displacing the sample relative to the measurement unit;
   c. Obtaining an additional image of an additional part of said sample, by the measurement unit, said additional image overlapping at least in part with a last obtained image;
   d. Forming a scanning sequence comprising multiple recently obtained images;
   e. Analyzing said scanning sequence for the presence of said biological particles, by a trained machine learning model, such as a convolutional neural network model, thereby obtaining a scanning indicator;
   f. Providing the scanning indicator and an image of the scanning sequence, such as the last image; and
   g. Repeating, a number of times, steps b-f;
   thereby continuously detecting and species classifying biological particles in the sample.
2. The method according to any one of the preceding items, wherein the biological particle is a mold spore, a mold, a bacterium, a virus particle, and/or a fragment thereof
3. The method according to any one of the preceding items, wherein the scanning sequence comprises or consists of a predetermined number of the most recently obtained images.
4. The method according to any one of the preceding items, wherein subsequently obtained images of the scanning sequence are obtained from, in part, overlapping parts of the sample.
5. The method according to any one of the preceding items, wherein images are obtained at a rate of at least 10 images per second.
6. The method according to any one of the preceding items, wherein the scanning sequence comprises or consists of images that has been obtained within the last two seconds from forming the scanning sequence.
7. The method according to any one of the preceding items, wherein the recently obtained images are obtained within two seconds of forming the scanning sequence.
8. The method according to any one of the preceding items, wherein the mold spores belongs to any of the following genera: Acremonium, Aureobasidium, Alternaria, Aspergillus, Botrytis, Chaetomium, Cladosporium, Epicoccum, Eurotium, Fusarium, Geotrichum, Monilia, Manoscus, Mortierella, Mucor, Neurospora, Oidium, Oospora, Penicillium, Rhizopus, Stachybotrys, Thamnidium, Trichoderma, Trichothecium, Trichophyton, and/or Wallemia.
9. The method according to any one of the preceding items, wherein the machine learning model is a convolutional neural network.
10. The method according to any one of the preceding items, wherein the machine learning model has been trained by supervised learning, unsupervised learning and/or a combination thereof.
11. The method according to any one of the preceding items, wherein the machine learning model has been trained using a labelled training data.
12. The method according to any one of the preceding items, wherein the labelled training data comprises or consists of DNA verified and/or expert labelled samples of biological particles.
13. The method according to any one of the preceding items, wherein the scanning indicator comprises or consists of an average from analysis of each image of the scanning sequence.
14. The method according to any one of the preceding items, wherein each image of the scanning sequence has been given a specific weight.
15. The method according to any one of the preceding items, wherein the scanning indicator is produced by a moving average.
16. The method according to any one of the preceding items, wherein the scanning indicator is obtained and/or provided substantially in real-time.
17. The method according to any one of the preceding items, wherein the scanning indicator is provided together with the recently obtained image, such as the last obtained image.
18. The method according to any one of the preceding items, wherein the scanning indicator comprises a classification of the biological particles present in the images of the scanning sequence, such as a most abundant biological particle species.
19. The method according to any one of the preceding items, wherein the scanning indicator comprises a significance level of the classification.
20. The method according to any one of the preceding items, wherein the scanning indicator is provided as a text and/or color coded, such as wherein the color coding represents the significance level.
21. The method according to any one of the preceding items, wherein the recently obtained image is the most recently obtained image.
22. The method according to any one of the preceding items, wherein the scanning indicator comprises the species of the biological particle that is most abundant in the scanning sequence.
23. The method according to any one of the preceding items, wherein the scanning indicator comprises multiple biological particle species.
24. The method according to any one of the preceding items, wherein the scanning indicator comprises an indication of an area in the recently obtained image comprising biological particles, such as a colored overlay.
25. The method according to any one of the preceding items, wherein the scanning indicator comprises a direction indicator, such as an arrow, indicating a direction to an area likely to comprise biological particles.
26. The method according to any one of the preceding items, wherein the scanning indicator comprises a number of scanning condition indicators, such as a lightning level, a scanning speed, a focus level, a background particle level, and/or a background contrast level.
27. The method according to any one of the preceding items, wherein the method further comprises processing of a measurement result, said measurement result comprising a summary of the scanning indicators obtained during scanning of the at least a part of the sample.
28. The method according to any one of the preceding items, wherein the sample is a food product, such as a dairy product, and/or a collection of particles obtained from a surface or extracted from a volume of air.
29. The method according to any one of the preceding items, wherein the step of providing the sample comprises collection of the sample by tape sampling.
30. The method according to any one of the preceding items, wherein the sample has been obtained from a surface, such as by tape sampling, or from the air, such as air sampling.
31. The method according to any one of the preceding items, wherein the sample comprises a tape, for sampling of biological particles, such as a tape adhered to a glass slide.
32. The method according to any one of the preceding items, wherein the measurement unit comprises an image sensor.
33. The method according to any one of the preceding items, wherein the measurement unit comprises a display unit, configured for displaying the obtained image and/or the scanning indicator.
34. The method according to any one of the preceding items, wherein the measurement unit is portable, such as a smartphone.
35. The method according to any one of the preceding items, wherein the measurement unit or the sample is fixed in position.
36. The method according to any one of the preceding items, wherein the sample is displaced at a constant speed and in a constant direction, such as a production line.
37. The method according to any one of the preceding items, wherein the measurement unit comprises means for communication with a remote server
38. The method according to any one of the preceding items, wherein the measurement unit is configured for transferring the obtained images to the remote server.
39. The method according to any one of the preceding items, wherein the measurement unit is configured for receiving, from the remote server, the scanning indicator, such as substantially in real time.
40. The method according to any one of the preceding items, wherein the analysis is performed on the measurement unit and/or the remote server.
41. A measurement unit for continuous detection and species classification of biological particles in a sample, the measurement unit being configured for:
   Continuously scanning along at least a part of the sample, said continuous scanning comprising:
      a. Obtaining an image of a part of said sample, by the measurement unit;
      b. Displacing the sample relative to the measurement unit;
      c. Obtaining an additional image of an additional part of said sample, by the measurement unit, said additional image overlapping at least in part with a last obtained image;
      d. Forming a scanning sequence comprising multiple recently obtained images;
      e. Analyzing said scanning sequence for the presence of said biological particles, by a trained machine learning model, such as a convolutional neural network model, thereby obtaining a scanning indicator;
      f. Providing the scanning indicator and an image of the scanning sequence, such as the last image; and
      g. Repeating, a number of times, steps b-f;
   thereby continuously detecting and species classifying biological particles in the sample.
42. The measurement unit according to item 41, wherein the measurement unit is configured for carrying out the method according to any one of items 1-40.
43. A system for continuous detection and species classification of biological particles in a sample, the system comprising:
   a. A measurement unit configured for:
      i. Scanning at least a part of the sample, such that a number of images along at least a part of said sample is obtained;
      ii. Transferring the obtained images to a remote server;
      iii. Providing an image of the scanning sequence and the scanning indicator;
      iv. Repeating, a number of times, steps i-iii;
   b. The remote server configured for:
      i. Receiving said obtained images;
      ii. Forming a scanning sequence comprising multiple recently received images;
      iii. Analyzing said scanning sequence for the presence of said biological particles, by a trained machine learning model, such as a convolutional neural network model, thereby obtaining a scanning indicator; and
      iv. Transferring the scanning indicator to the measurement unit.
44. The system according to item 43, wherein the apparatus is configured for carrying out the method according to any one of items 1-40.
45. The system according to any one of items 43-44, wherein the measurement unit is configured according to any one of items 41-42.

1. A method for continuous detection and species classification of biological particles in a sample, the method comprising:
a. Obtaining an image of a part of said sample, by a measurement unit;
b. Displacing the sample relative to the measurement unit;
c. Obtaining an additional image of an additional part of said sample, by the measurement unit;
d. Forming a scanning sequence comprising multiple recently obtained images;
e. Analyzing said scanning sequence for the presence of said biological particles, by a trained machine learning model, thereby obtaining a scanning indicator; and
f. Repeating, a number of times, steps b-e;
thereby continuously detecting and species classifying biological particles in the sample.

2. The method according to any one of the preceding claims, wherein the scanning sequence, comprising the most recently obtained images, is for each repetition, provided to the machine learning model and used to derive the scanning indicator.

3. The method according to any one of the preceding claims, wherein the number of images of the scanning sequence is automatically adjusted, for each repetition, based on the scanning indicator.

4. The method according to any one of the preceding claims, wherein the method further comprises a step of providing, between the step of analyzing and the step of repeating, said step of providing comprising:
Providing the scanning indicator to a user and/or a control system; and wherein the step of repeating comprises repeating said step of providing.

5. The method according to claim 4, wherein the step of providing further comprises providing an image of the scanning sequence, such as the most recently obtained image of the scanning sequence.

6. The method according to any one of claim 5, wherein the scanning indicator is provided to the user and/or the control system, that is controlling what area of the sample that is imaged, and wherein said user and/or control system, for each repetition, displaces the sample relative to the measurement unit, to image another area, based on the scanning indicator.

7. The method according to claim 6, wherein the scanning indicator comprises information about the portion of the sample that has been analyzed and wherein the method is repeated until at least a predetermined portion of the sample has been imaged.

8. The method according to claim 7, wherein the predetermined portion of the sample has been determined during a benchmarking training phase of the machine learning model, where the predetermined portion is the portion of the sample that is required to be imaged in order to obtain accurate detection and species classification of biological particles.

9. The method according to claim 8, wherein the portion of the sample that is required to be imaged, is determined during a benchmark phase wherein the analysis of the machine learning model at different portions of the sample is compared to reference methods; and wherein the predetermined portion is set by the minimum portion resulting in accurate detection and species classification.

10. The method according to any one of claims 6-9, wherein the scanning indicator comprises a direction indicator, indicating a direction of the sample, with respect to the presently imaged area, with a high likeliness of having biological particles, such as mold.

11. The method according to any one of the preceding claims, wherein the biological particle is a mold spore, a mold, a bacterium, a virus particle, and/or a fragment thereof.

12. The method according to any one of the preceding claims, wherein the machine learning model is a convolutional neural network that has been trained by DNA verified and/or expert labelled samples of biological particles.

13. The method according to any one of the preceding claims, wherein the displacement of the sample relative to the measurement unit, is continuously controlled by a user, and wherein the scanning indicator is continuously provided together with the image of the scanning sequence, to said user.

14. The method according to any one of the preceding claims, wherein each repeatedly formed scanning indicator is provided less than one second from obtaining the oldest obtained image of the scanning sequence from which said scanning indicator was formed.

15. The method according to any one of the preceding claims, wherein the scanning indicator comprises a classification of the most abundant biological particle species present in the images of the scanning sequence.

16. The method according to any one of the preceding claims, wherein the scanning indicator comprises multiple biological particle species and wherein the scanning indicator comprises a significance level of the classification of each biological particle species.

17. The method according to any one of the preceding claims, wherein the scanning indicator comprises one or more indicators of one or more scanning conditions of the obtaining of the images of the scanning sequence, said scanning conditions including any of a lightning level, a scanning speed level, a focus level, a background particle level, and/or an indicator of a background contrast level.

18. The method according to any one of the preceding claims, wherein the scanning sequence consists of a dynamic number of the most recently obtained images and wherein said number is continuously adjusted based on the results from analysis of the scanning conditions, by the machine learning model.

19. The method according to any one of the preceding claims, wherein the sample has been obtained from a surface, such as by tape sampling, or from the air, such as air sampling.

20. The method according to any one of the preceding claims, wherein the measurement unit is fixed in position and wherein the sample is displaced at a constant speed and in a constant direction, such as a production line.

21. The method according to any one of the preceding claims, wherein the method comprises continuously scanning along at least a part of the sample; and/or wherein said additional image overlapping at least in part with a last obtained image; and/or wherein the step further comprises a step of providing, between step e. and step f., said step of providing comprising: Providing the scanning indicator and an image of the scanning sequence, such as the last image, and wherein the step of Repeating further comprises repeating said step of providing.

22. A measurement unit for continuous detection and species classification of biological particles in a sample, the measurement unit being configured for:
Continuously scanning along at least a part of the sample, said continuous scanning comprising:
a. Obtaining an image of a part of said sample, by the measurement unit;
b. Displacing the sample relative to the measurement unit;
c. Obtaining an additional image of an additional part of said sample, by the measurement unit;
d. Forming a scanning sequence comprising multiple recently obtained images;
e. Analyzing said scanning sequence for the presence of said biological particles, by a trained machine learning model, such as a convolutional neural network model, thereby obtaining a scanning indicator;
f. Repeating, a number of times, steps b-e.

23. The measurement unit according to claim 22, wherein the measurement unit is configured for carrying out the method according to any one of claims 1-20, thereby continuously detecting and species classifying biological particles in the sample.

24. The measurement unit according to any one of claims 22-23, comprising a control system, arranged for displacing the sample relative to the measurement unit, and for receiving the scanning indicator, and wherein said control system is further arranged to displace the sample based on the scanning indicator, such as wherein the scanning indicator comprises a direction indicator.

25. The measurement unit according to any one of claims 22-24, comprising a control unit for displacing the sample relative to the measurement unit.

26. The measurement unit according to 25, wherein the measurement unit is configured to provide a scanning indicator comprising a direction indication to the control unit, and wherein said control unit is arranged to displace the sample relative to the measurement unit according to the direction indication.

27. A system for continuous detection and species classification of biological particles in a sample, the system comprising:
A measurement unit configured for:
a. Scanning at least a part of the sample, such that a number of images along at least a part of said sample is obtained;
b. Transferring the obtained images, to a remote server;
c. Receiving a scanning indicator, from the remote server;
d. Providing an image of the scanning sequence and the scanning indicator;
e. Repeating, a number of times, steps a-d;
The remote server configured for:
i. Receiving said obtained images, from the measurement unit;
ii. Forming a scanning sequence comprising multiple recently received images;
iii. Analyzing said scanning sequence for the presence of said biological particles, by a trained machine learning model, such as a convolutional neural network model, thereby obtaining a scanning indicator;
iv. Transferring the scanning indicator to the measurement unit; and
v. Repeating, a number of times, steps i.-iv.

28. The system according to claim 27, wherein the measurement unit is configured according to any one of claims 22-26; and/or wherein the measurement unit is configured for carrying out the method according to any one of claims 1-21.
